(19) United States
(12) Patent Application Publication
(10) Pub. No.: US 2026/0064563 A1
(43) Pub. Date: Mar. 5, 2026

(54) VERIFIER DEVICE, VERIFICATION METHOD, STORAGE MEDIUM STORING VERIFICATION PROGRAM, AND REMOTE ATTESTATION SYSTEM

(71) Applicant: DENSO CORPORATION, Kariya-city (JP)

(72) Inventors: Madoka ASAI, Kariya-city (JP); Tomonori IKUSE, Kariya-city (JP); Yasuharu SUGANO, Kariya-city (JP); Takeshi NAKAMURA, Kariya-city (JP); Carlos MORA-GOLDING, Southfield, MI (US); Ameer KASHANI, Southfield, MI (US)

(21) Appl. No.: 18/822,795

(22) Filed: Sep. 3, 2024

(51) Int. Cl. G06F 11/36

(52) U.S. Cl. CPC G06F 11/3608

(57) ABSTRACT

A verifier device in a remote attestation system including a prover device and a verifier device is provided. The verifier device includes: an evidence data reception unit configured to receive evidence data, which is software, from a prover device that places and executes the software in a memory; a master storage unit configured to store master software, which is a copy of the software; a difference extraction unit configured to extract a difference between the evidence data received and the master software; a cause determination unit configured to determine a cause of modification of the software based on the difference; and a cause information output unit configured to output cause information indicating the cause determined.

### TECHNICAL FIELD

The present disclosure relates to a verifier device that determines a cause of loss of integrity of software based on evidence data transmitted from a prover device to the verifier device in a remote attestation system where the verifier device verifies the integrity of software executed mainly by the prover device. As an example, the present disclosure relates to a remote attestation system in which all or some of devices constituting the system are mounted in a vehicle.

### BACKGROUND

Related art discloses a remote attestation scheme that verifies the integrity of processes and systems in execution. In the related art, a prover obtains a start address and size, and measurement result of a process or system memory region and transmits these to a verifier. The verifier verifies the integrity of the prover by comparing a correct value prepared in advance, or a correct value calculated based on the received information, with the received measurement result.

### SUMMARY

A verifier device in a remote attestation system including a prover device and a verifier device is provided. The verifier device includes: an evidence data reception unit configured to receive evidence data, which is software, from a prover device that places and executes the software in a memory; a master storage unit configured to store master software, which is a copy of the software; a difference extraction unit configured to extract a difference between the evidence data received and the master software; a cause determination unit configured to determine a cause of modification of the software based on the difference; and a cause information output unit configured to output cause information indicating the cause determined.

### BRIEF DESCRIPTION OF THE DRAWINGS

The objects, features, and advantages of the present disclosure will become more apparent from the following detailed description made with reference to the accompanying drawings. In the drawings:

FIGS. 1A to 1C are explanatory diagrams illustrating the arrangement of a prover device, a verifier device, and a remote attestation system;

FIG. 2 is an explanatory diagram illustrating the arrangement of the prover device and the verifier device in a vehicle;

FIG. 3 is a block diagram illustrating a configuration example of the prover device according to the first embodiment;

FIGS. 4A and 4B are explanatory diagrams illustrating a measurement instruction received by a measurement instruction reception unit and processing contents of a measurement unit;

FIG. 5 is an explanatory diagram illustrating failure identification data stored in the failure identification data;

FIG. 6 is a block diagram illustrating a configuration example of a verifier device according to the first embodiment;

FIG. 7 is an explanatory diagram illustrating information stored in advance in the storage unit of the verifier device;

FIG. 8 is an explanatory diagram illustrating a measurement instruction transmitted from the verifier device to the prover device;

FIG. 9 is an explanatory diagram illustrating a measurement result transmitted from the verifier device to the prover device;

FIG. 10 is an explanatory diagram illustrating an evidence request instruction transmitted from the verifier device to the prover device;

FIG. 11 is an explanatory diagram illustrating evidence data transmitted from the prover device to the verifier device;

FIGS. 12A and 12B are explanatory diagrams illustrating modification feature data stored in a feature data storage unit; and

FIG. 13 is a flow diagram illustrating the operation of the verifier device according to the first embodiment.

### DETAILED DESCRIPTION

In recent years, various electronic control devices connected through in-vehicle networks are mounted in automobiles, and software is executed in each electronic control device. However, there is a possibility that such software may be tampered with by a cyberattack or the like due to being compromised, causing the software to operate differently from the original plan. To address these issues, the use of remote attestation is being considered. Remote attestation is a mechanism that can confirm the integrity of a device or software on the device during remote operation or the like for the purpose of device management and operation.

As a result of detailed studies, the present inventor has found the following difficulties. In the remote attestation scheme, if the integrity of the prover cannot be confirmed, the verifier knows that a software modification has occurred. However, such a software modification may occur not only due to a cyberattack but also due to a failure such as noise or a malfunction that has occurred in the prover. It is thus desirable to determine whether the cause of the loss of the integrity of the prover is due to a cyberattack or a failure.

Therefore, an object of the present disclosure is to implement a verifier device or the like capable of collecting raw data of a memory region as evidence data after remote attestation and determining a cause of rewriting of software based on the evidence data.

According to one aspect of the present disclosure, a verifier device in a remote attestation system including a prover device and a verifier device is provided. The prover device transmits a measurement result in response to a measurement instruction from the verifier device, and the verifier device transmits an evidence collection instruction requesting evidence data in response to the measurement result from the prover device, and the prover device transmits the evidence data in response to the evidence collection instruction from the verifier device. The verifier device includes: an evidence data reception unit configured to receive the evidence data, which is software, from the prover device that places and executes the software in a memory; a master storage unit configured to store master software, which is a copy of the software; a difference extraction unit configured to extract a difference between the evidence data received and the master software; a cause determination unit configured to determine a cause of modification of the software based on the difference; and a cause information output unit configured to output cause information indicating the cause determined.

With the above configuration, the verifier device and the like according to the present disclosure can determine a cause of a software modification by comparing software, which is evidence data acquired from the prover device, with master software.

Hereinafter, embodiments of the present disclosure will be described with reference to the drawings.

When there are a plurality of embodiments (including modified examples, as the same applies hereinafter in this section), the configuration disclosed in each embodiment is not limited to that embodiment alone, but can be combined across embodiments. For example, the configuration disclosed in one embodiment may be combined with another embodiment. The configurations disclosed respectively in a plurality of embodiments may be collected and combined.

### 1. Premise of Each Embodiment

### (1) Arrangement of Prover Device 100, Verifier Device 200, and Remote Attestation System 1

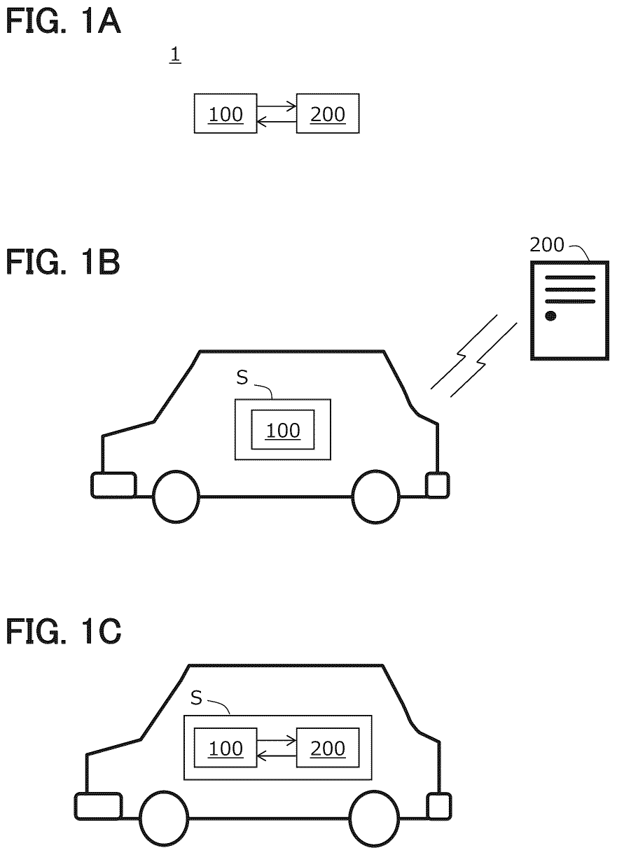

FIGS. 1A to 1C are diagrams illustrating the arrangement of a prover device 100, a verifier device 200, and a remote attestation system 1. First, an outline of each device and its connection method will be described with reference to FIG. 1A.

The prover device 100 is a device that places “software” in “memory” and executes the software. This device is a device that is a target for proving the integrity of the software executed, that is, a device that provides evidence information for proving its own integrity. Therefore, the device is referred to as a prover device.

The verifier device 200 is a device that verifies the integrity of “software” executed by the prover device 100, that is, a device that verifies the integrity of the prover device based on the evidence information received from the prover device. Therefore, the device is referred to as a verifier device.

The prover device 100 and the verifier device 200 are collectively referred to as the remote attestation system 1.

The “software” includes not only a case where the software is made up of program code and data but also a case where the software is made up of only program code or only data.

For the “memory”, a position-identifiable readable/writable recording medium is sufficient, which may include nonvolatile memory such as flash memory or a hard disk, in addition to volatile memory such as random-access memory.

The prover device 100 and the verifier device 200 are connected using a wired communication method or a wireless communication method to transmit and receive a measurement instruction, a measurement result, an evidence collection instruction, evidence data, and the like, which will be described later.

Examples of the wired communication method include the Internet, a fixed telephone line, and Ethernet (registered trademark). When an in-vehicle network is used, a controller area network (CAN) or a local interconnect network (LIN) can be used.

Examples of the wireless communication method include IEEE802.11 (Wi-Fi (registered trademark)), IEEE802.16 (WiMAX (registered trademark)), wideband code division multiple access (W-CDMA), high-speed packet access (HSPA), long-term evolution (LTE), long-term evolution advanced (LTE-A), fourth generation (4G), fifth generation (5G), and the like. In addition, dedicated short-range communication (DSRC), Bluetooth low energy (BLE), or Bluetooth (registered trademark) may be used.

As to which communication method to use, it is sufficient to adopt an optimal communication method according to the positions at which the prover device 100 and the verifier device 200 are installed, the distance therebetween, and other factors.

The communication between the prover device 100 and the verifier device 200 is desirably protected by a secure communication protocol such as mTLS.

The positions where the prover device 100 and the verifier device 200 are disposed are arbitrary. That is, the positions of the prover device 100 and the verifier device 200 and the distance between the prover device 100 and the verifier device 200 are arbitrary.

For example, as illustrated in FIG. 1B, the prover device 100 may be mounted in a vehicle, and the verifier device 200 may be provided outside the vehicle. For example, the prover device 100 may be an “electronic control device” (electric control unit, ECU) “mounted” in a vehicle that is a “moving object”, and the verifier device 200 may be a server device installed outside the vehicle that is the “moving object”. That is, the prover device 100 is located inside an electronic control system S, and the verifier device 200 is located outside the electronic control system S. The electronic control device is a device constituting the electronic control system of the vehicle. In this case, the prover device 100 and the verifier device 200 are connected by, for example, Wi-Fi or 5G.

Alternatively, as illustrated in FIG. 1C, both the prover device 100 and the verifier device 200 may be mounted in the vehicle. For example, the prover device 100 may be an “electronic control device” “mounted” in the vehicle that is the “moving object”, and the verifier device 200 may be another “electronic control device” “mounted” in the vehicle that is the “moving object”. That is, both the prover device 100 and the verifier device 200 are located inside the electronic control system S. In this case, the prover device 100 and the verifier device 200 are connected by Ethernet or CAN.

In addition, both the prover device 100 and the verifier device 200 may be provided outside the vehicle, regardless of which vehicle.

The “moving object” refers to a movable object, and a moving speed is arbitrary. Naturally, a case where the moving object is stopped is also included. Examples thereof include, but are not limited to, an automobile, a motorcycle, a bicycle, a pedestrian, a ship, an aircraft, and an object mounted therein.

The term “mounted” includes not only a case where the device is directly fixed to the moving object but also a case where the device is not fixed to the moving object but moves together with the moving object. Examples thereof include a case where a person on the moving object carries the device and a case where the device is mounted in a load placed on the moving object.

The “electronic control device” may be a virtualized electronic control device implemented using virtualization technology, in addition to a physically independent electronic control device.

In each embodiment to be described later, a description will be given on the premise of the arrangement of FIG. 1B.

### (2) Arrangement of Prover Device 100 and Verifier Device 200 in Vehicle

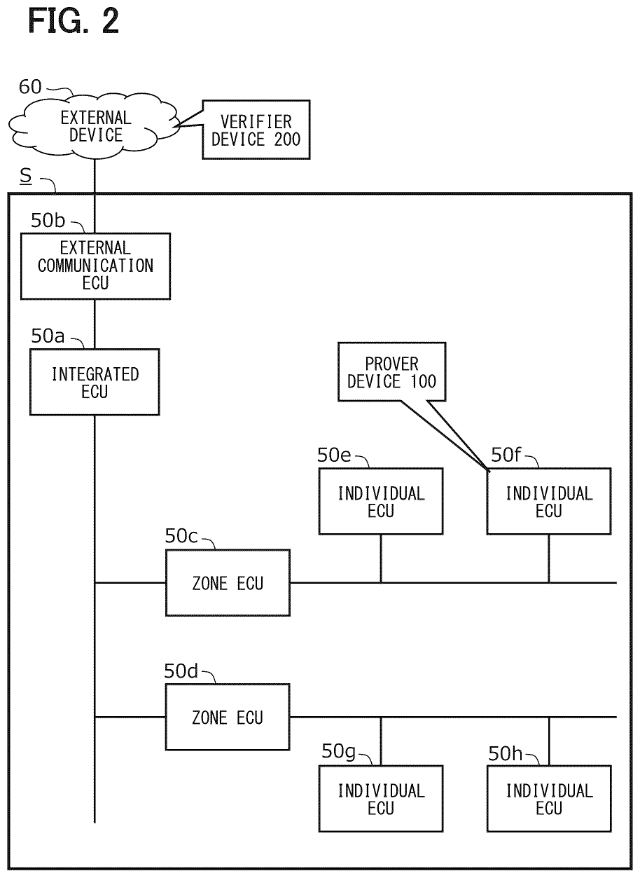

FIG. 2 is a diagram illustrating the electronic control system S mounted in the vehicle and an example of the arrangement of the prover device 100 and the verifier device 200 in the electronic control system S.

The electronic control system S includes a plurality of ECUs 50 and an in-vehicle network that connects these ECUs. FIG. 2 illustrates eight ECUs (ECU 50a to ECU 50h), but naturally, the electronic control system S includes any number of ECUs. In the following description, ECU 50 or each ECU 50 is used to collectively describe one or more electronic control devices as a whole, and ECU 50a, ECU 50b, ECU 50c, . . . are used to identify and describe individual electronic control devices.

In the case of FIG. 2, the ECUs 50 are connected via an in-vehicle communication network such as a controller area network (CAN) or a local interconnect network (LIN). Alternatively, the connection may be made using any wired or wireless communication method, such as Ethernet (registered trademark), Wi-Fi (registered trademark), or Bluetooth (registered trademark).

The connection refers to a state where data can be exchanged and includes not only a case where different pieces of hardware are connected via a wired or wireless communication network, but also a case where virtual ECUs (also referred to as virtual machines) implemented on the same hardware are connected to each other virtually.

The electronic control system S illustrated in FIG. 2 includes an integrated ECU 50a, an external communication ECU 50b, zone ECUs (50c, 50d), and individual ECUs (50e to 50h).

The integrated ECU 50a is an ECU equipped with a function to control the entire electronic control system S and a gateway function to mediate communication between the ECUs 50. The integrated ECU 50a may also be referred to as a gateway ECU (G-ECU) or a mobility computer (MC). The integrated ECU 50a may be a relay device or a gateway device.

The external communication ECU 50b is an ECU including a communication unit that communicates with an external device 60 provided outside the vehicle. The communication method used by the external communication ECU 50b is the wireless communication method or the wired communication method described in FIGS. 1A to 1C.

To implement a plurality of communication methods, a plurality of external communication ECUs 50b may be provided. Instead of providing the external communication ECU 50b, the integrated ECU 50a may include the function of the external communication ECU 50b.

The zones ECU (50c, 50d) are ECUs equipped with gateway functions appropriately disposed according to the arrangement places and functions of the individual ECUs (50e to 50h). For example, the zone ECU 50c is an ECU with a gateway function that mediates communication between the individual ECU 50e and the individual ECU 50f arranged in the front of the vehicle and another ECU 50. The zone ECU 50d is an ECU with a gateway function that mediates communication between the individual ECU 50g and the individual ECU 50h arranged in the rear of the vehicle and another ECU 50.

The individual ECUs (50e to 50h) can be configured by ECUs with any function. Examples thereof include: a drive system electronic control device that controls the engine, steering wheel, brake, and the like; a vehicle body system electronic control device that controls the meter, power window, and the like; an information system electronic control device such as a navigation device; and a safety control system electronic control device that performs control to prevent collision with obstacles or pedestrians. The ECUs 50 may not be arranged in parallel, and may be classified into a master and a slave.

Each ECU 50 stores software corresponding to its function and reads the software into memory for execution as necessary. Accordingly, each ECU 50 can be the prover device 100.

In FIG. 2, a case where the individual ECU 50f is the prover device 100 will be described as an example.

When the verifier device 200 is provided outside the vehicle as illustrated in FIG. 1B, the external device 60 of FIG. 2 is the verifier device 200. When the verifier device 200 is mounted in the vehicle as illustrated in FIG. 1C, for example, the integrated ECU 50a can be set as the verifier device 200.

### 2. First Embodiment

### (1) Configuration of the Prover Device 100

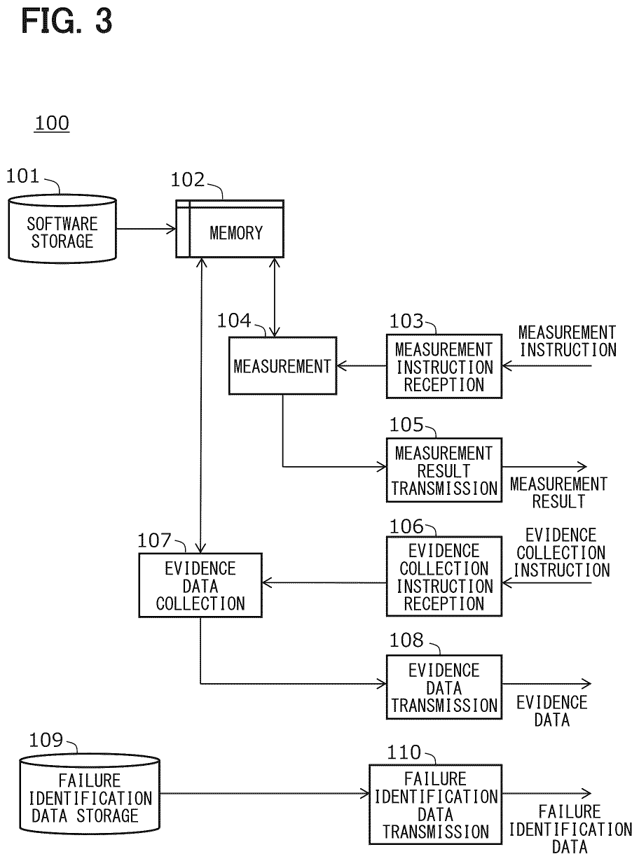

A configuration example of the prover device 100 according to the present embodiment will be described with reference to FIG. 3. The prover device 100 includes a software storage unit 101, memory 102, a measurement instruction reception unit 103, a measurement unit 104, a measurement result transmission unit 105, an evidence collection instruction reception unit 106, an evidence data collection unit 107, an evidence data transmission unit 108, a failure identification data storage unit 109, and a failure identification data transmission unit 110.

The prover device 100 can include a general-purpose central processing unit (CPU), volatile memory such as random-access memory (RAM), nonvolatile memory such as read-only memory (ROM), flash memory, or a hard disk, various interfaces, and internal bus that connects these components. By executing software on these pieces of hardware, it is possible to perform the function of each functional block illustrated in FIG. 3. The same applies to the verifier device 200 to be described later.

The prover device 100 reads the software stored in the software storage unit 101 into the memory 102 to place the software in the memory and execute the software. The placement position of the software in the memory may be either the same at all times or different at each reading. When the position is different for each reading, it is desirable to share the placement position with the verifier device 200. When the memory 102 is a random-access memory (RAM), the placement position can be indicated by, for example, a start address indicating the leading position of the software and the size of the software. The size of the software may be omitted when the size of the software is known in the verifier device 200. Alternatively, the placement position is a start address indicating the leading position and an end address indicating the trailing position.

The measurement instruction reception unit 103 receives a measurement instruction generated by the verifier device 200 from the verifier device 200. In the present embodiment, the measurement instruction includes measurement region information indicating a region to be measured in the software. The measurement region information only needs to be information that can specify all or a part of the software in the memory, and examples thereof include an address and a size.

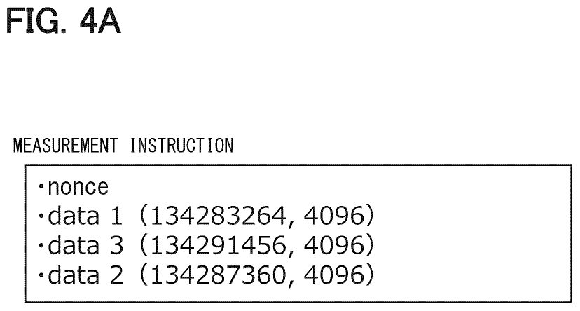

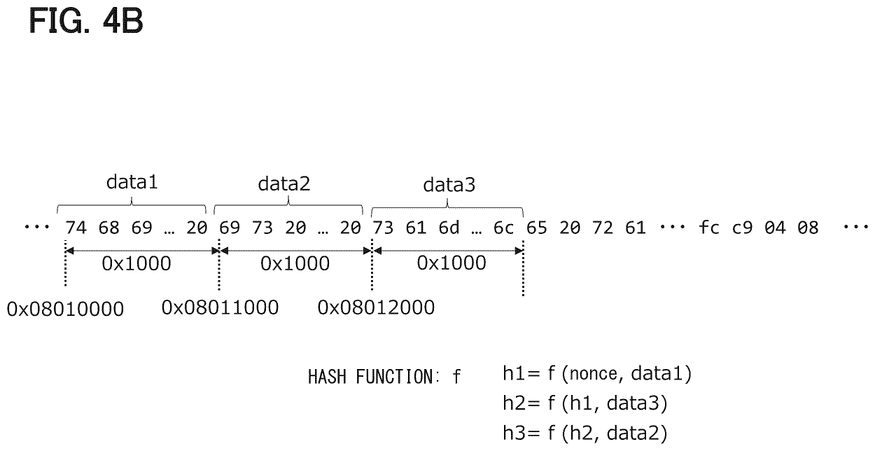

A specific example of the measurement instruction received by the measurement instruction reception unit 103 will be described with reference to FIGS. 4A and 4B. In the case of FIG. 4A, the received measurement instruction includes three regions as measurement region information in addition to a nonce. The first region is indicated by data1, with a start address of 134283264 (decimal notation), and a size of 4096 bytes. The second region is indicated by data3, with a start address of 134291456 (decimal notation), and a size of 4096 bytes. A third region is indicated by data2, with a start address of 134287360 (decimal notation), and a size of 4096 bytes.

This measurement instruction also includes an instruction to execute measurement in the order of data1, data3, and data2. That is, the order of data1, data3, and data2 corresponds to the measurement order information.

The nonce is, for example, a random number generated by the verifier device 200, but may also be any numerical value with low predictability, even if not completely random.

Based on the measurement instruction received by the measurement instruction reception unit 103, the measurement unit 104 reads software placed in the memory 102 and calculates a measurement value. In the present embodiment, a “hash value” is calculated as the measurement value.

The “hash value” is an output value itself calculated by a function that calculates a unique value for an input value, or a value obtained by performing processing such as encryption on the output value, and an algorithm used for the function is arbitrary. For example, the “hash values” include not only a value calculated by a one-way hash function such as SHA512 but also a value calculated by a cipher-based MAC (CMAC), a value calculated by a hash-based MAC (HMAC), and a signature.

In FIG. 4B, data1 of the software placed in the memory 102 has a start address of 0x08010000 (hexadecimal notation) and a size of 0x1000 (hexadecimal notation), data3 has a start address of 0x08012000 (hexadecimal notation) and a size of 0x1000 (hexadecimal notation), and data2 has a start address of 0x08011000 (hexadecimal notation) and a size of 0x1000 (hexadecimal notation). Therefore, based on the respective arguments, the measurement unit 104 reads the corresponding ranges of the software and calculates the respective hash values as follows:
h1=f (nonce, data1)
h2=f (h1, data3)
h3=f (h2, data2)
(where f is a hash function).

The start address may be included as the argument of the hash function.

In FIGS. 4A and 4B, the hash value is calculated by dividing the measurement region into three regions based on the measurement region information and the measurement order information included in the measurement instruction. However, if the measurement instruction does not include an instruction to divide the region, the hash value may be calculated using the nonce and the raw data of the software in the memory 102.

The measurement result transmission unit 105 transmits the hash value calculated and obtained by the measurement unit 104 to the verifier device 200 as a measurement result. In the case of FIGS. 4A and 4B, the measurement result transmission unit 105 transmits the hash values h1, h2, h3.

In addition to the hash value, a time when the hash value was obtained and error information indicating the address and size of the region to be measured for which measurement has failed may also be transmitted.

Based on the measurement result transmitted from the measurement result transmission unit 105, the evidence collection instruction reception unit 106 receives the evidence collection instruction generated by the verifier device 200. For example, when the verifier device 200 detects a modification of software being executed in the memory 102 of the prover device 100, the verifier device 200 generates and transmits an evidence collection instruction to the prover device 100, requesting the transmission of the software being executed, which was used by the measurement unit 104 to calculate the hash value, as evidence data. The evidence collection instruction reception unit 106 receives this evidence collection instruction.

Based on the evidence collection instruction received by the evidence collection instruction reception unit 106, the evidence data collection unit 107 collects evidence data. For example, the measurement unit 104 reads the software used to calculate the hash value from the memory 102 to perform the collection.

The evidence data transmission unit 108 transmits the collected evidence data to the verifier device 200. When the verifier device 200 is a server device installed outside the vehicle as illustrated in FIG. 1B, the individual ECU 50f, that is, the prover device 100, outputs evidence data to an in-vehicle network such as CAN, and transmits the evidence data from the external communication ECU 50b via the zone ECU 50 and the integrated ECU 50a. In contrast, when the verifier device 200 is an ECU mounted in the vehicle as illustrated in FIG. 1C, the individual ECU 50f, that is, the prover device 100, outputs evidence data to an in-vehicle network such as CAN.

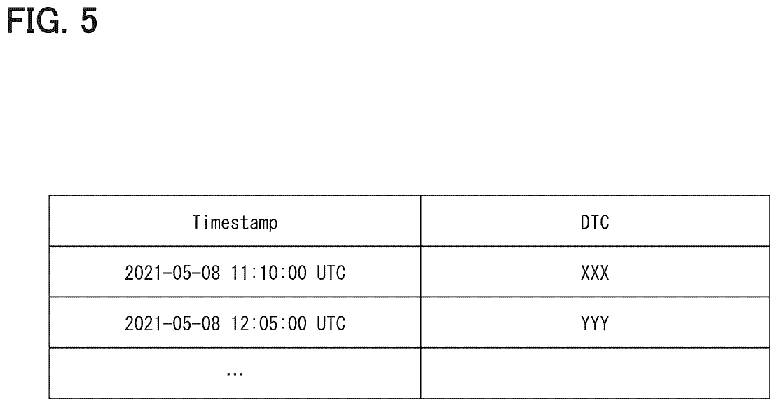

The failure identification data storage unit 109 stores “failure identification data” that can identify that a failure has occurred in the individual ECU 50f, that is, the prover device 100. A specific example of the information stored in the failure identification data storage unit 109 will be described with reference to FIG. 5. In the failure identification data storage unit 109, the time when the failure identification data is generated or when the failure identification data is stored in the failure identification data storage unit 109, and a diagnostic trouble code (DTC), which is the failure identification data, are associated and stored. The DTC is a code generated when a self-diagnosis function provided in the ECU 50 detects a failure, and is also referred to as a failure code.

The “failure identification data” may be not only a notification directly indicating that a failure has occurred but also data indirectly indicating that a failure has occurred.

In the present embodiment, the case where the failure identification data is the DTC is described as an example, but the present invention is not limited to the DTC. The failure identification data may be, for example, freeze frame data generated when a failure occurs in the prover device 100 or a collection of a plurality of pieces of log data indicating the state of the vehicle detected by various sensors mounted in the vehicle. In the former case, the occurrence of the failure can be identified from the fact that freeze frame data has been generated. In the latter case, a failure can be detected based on a plurality of pieces of log data indicating the state of the vehicle, such as vehicle speed, engine speed, and temperature. Thus, these pieces of log data can also be considered failure identification data that can identify the occurrence of a failure.

The failure identification data transmission unit 110 transmits, to the verifier device 200, the failure identification data stored in the failure identification data storage unit 109. The timing for transmitting the failure identification data can be determined arbitrarily. For example, the failure identification data transmission unit 110 transmits the failure identification data to the verifier device 200 as soon as the failure identification data is stored in the failure identification data storage unit 109. Alternatively, the failure identification data may be transmitted when the measurement instruction reception unit 103 receives the measurement instruction from the verifier device 200 or when the evidence collection instruction reception unit 106 receives the evidence collection instruction from the verifier device 200. In these cases, the failure identification data may be transmitted to the verifier device 200 together with the measurement result or the evidence data. When the failure identification data is transmitted to the verifier device 200 together with the measurement result or the evidence data, the measurement result transmission unit 105 or the evidence data transmission unit 108 may function as the failure identification data transmission unit 110.

### (2) Configuration of Verifier Device 200

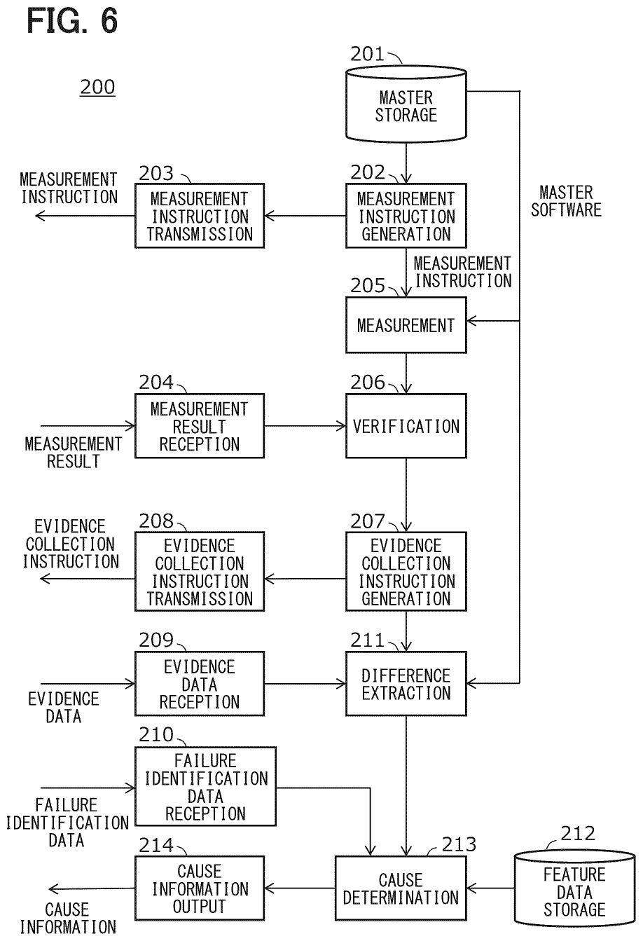

A configuration example of the verifier device 200 according to the present embodiment will be described with reference to FIG. 6. The verifier device 200 includes a master storage unit 201, a measurement instruction generation unit 202, a measurement instruction transmission unit 203, a measurement result reception unit 204, a measurement unit 205, a verification unit 206, an evidence collection instruction generation unit 207, an evidence collection instruction transmission unit 208, an evidence data reception unit 209, a failure identification data reception unit 210, a difference extraction unit 211, a feature data storage unit 212, a cause determination unit 213, and a cause information output unit 214.

In the master storage unit 201, information regarding software stored or installed in the prover device 100 is stored in advance. This software is software that is executed in the prover device 100 and is a target of the measurement instruction.

The master storage unit 201 may be either an external storage device (hard disk, universal serial bus (USB) memory, compact disc (CD)/Blu-ray disc (BD), etc.) or an internal storage device (RAM, etc.). The device may be volatile or nonvolatile.

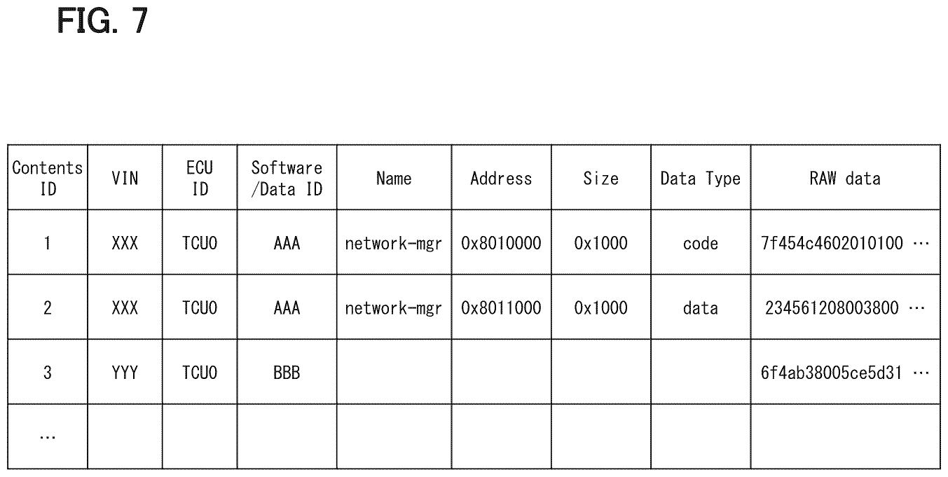

A specific example of the information stored in the master storage unit 201 will be described with reference to FIG. 7.

The master storage unit 201 stores a measurement target table that records information of software to be measured. As illustrated in FIG. 7, the measurement target table associates and stores a content identifier (Contents ID) that identifies software, a vehicle identifier (VIN) that identifies a vehicle in which the software is mounted, an identifier (ECU ID) of an ECU in which the software is installed, an identifier (Software/Data ID) that identifies a program or data included in the software, the name (Name) of the software, the start position (Address) of the software in memory, the size (Size) of the software, the data type (Data Type) of the software, and raw data (RAW data) of master software, which is a “copy” of the software installed on the prover device 100.

The “copy” of the software refers to the same content as the software, and it does not matter whether the software is copied from the original. For example, the software may have been produced as an original, or the “copy” itself may be an original.

The measurement instruction generation unit 202 generates a measurement instruction for the prover device 100. In the present embodiment, a measurement instruction is generated to instruct the calculation of a hash value that is a measurement value of the software executed by the prover device 100.

In the present embodiment, the measurement instruction includes measurement region information indicating a region to be measured in the software. For example, as in the example of FIG. 4A, the measurement instruction includes a nonce and a plurality of pieces of measurement region information (data1, data3, data2), and also includes measurement order information (data1, data3, data2) indicating an order in which the plurality of pieces of measurement region information are to be processed.

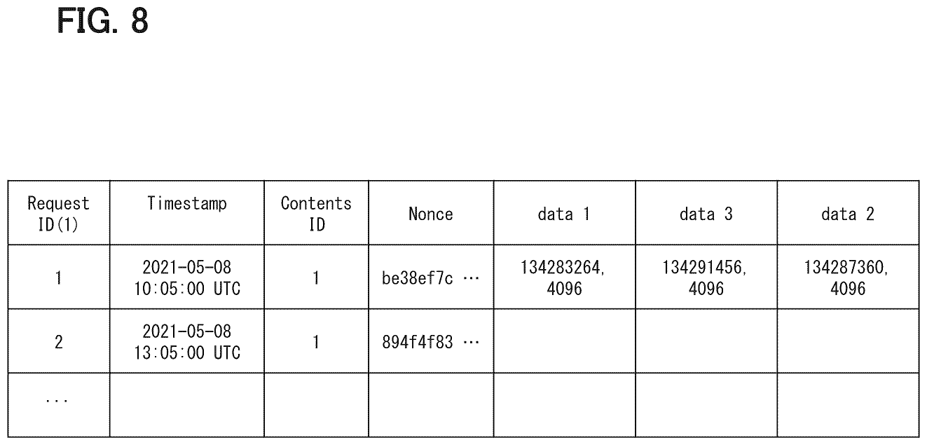

A specific example of the measurement instruction generated by the measurement instruction generation unit 202 will be described with reference to FIG. 8. In the example of FIG. 8, the measurement instruction includes the identifier (Request ID (1)) of the measurement instruction, a time (Timestamp) when the measurement instruction generation unit 202 generates the measurement instruction or when the measurement instruction transmission unit 203 transmits the measurement instruction, a content identifier (Contents ID) that identifies software being executed by the prover device 100, a nonce (Nonce), and measurement region information (data1, data3, data2). When the calculation of the hash value for the entire software is instructed, the measurement region information is unnecessary.

In addition, a vehicle identifier (VIN) that identifies a vehicle, an identifier (ECU ID) of an ECU in which software is installed, and an identifier (Software/Data ID) that identifies a program or data included in executed software may be included.

The measurement instruction transmission unit 203 transmits, to the prover device 100, the measurement instruction generated by the measurement instruction generation unit 202. The timing for transmitting the measurement instruction can be determined arbitrarily. For example, the measurement instruction may be generated and transmitted periodically at regular intervals, or the measurement instruction may be generated and transmitted when an anomaly occurs. Examples of the time when an anomaly occurs include when an anomaly caused by a cyberattack is identified by a vehicle security operation center (SOC) or when a product security incident response team (PSIRT) determines that verification of integrity is necessary. These examples are compatible when the verifier device 200 is provided outside the vehicle. The examples also include when a security sensor such as a host-based intrusion detection system (IDS) or a network-based intrusion detection system (IDS) provided in the electronic control system S of FIG. 2 detects an anomaly or when the in-vehicle security information and event management (SIEM) has finished selecting an anomaly to be examined. These examples are compatible when the verifier device 200 is provided inside the vehicle.

Other examples of the timing include when an ignition power supply is turned off, and when a power supply is turned off in an ECU of a specific group.

The measurement result reception unit 204 receives a measurement result that is the response of the prover device 100 to the measurement instruction transmitted from the measurement instruction transmission unit 203. For example, when the prover device 100 obtains hash values in FIG. 4B by calculation, these hash values h1, h2, h3 are the measurement results.

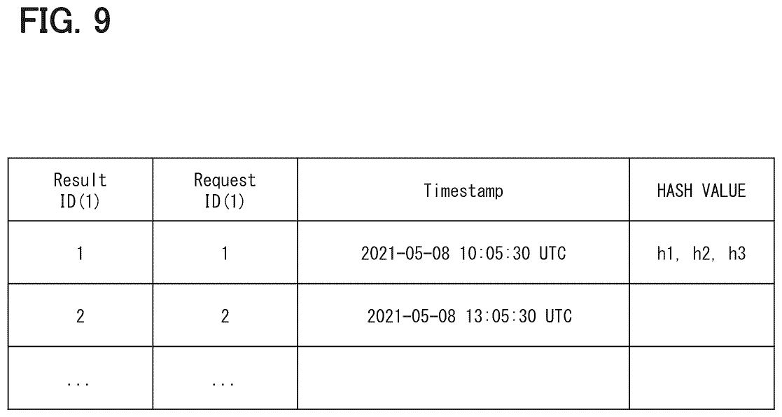

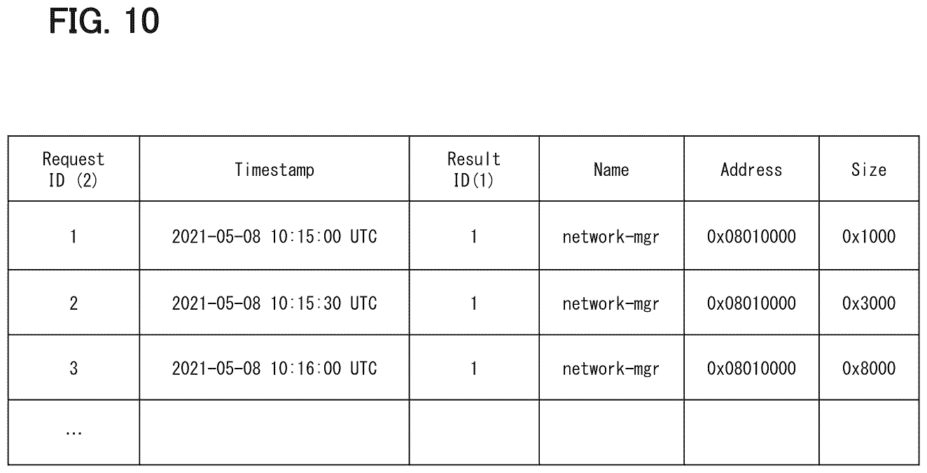

A specific example of the measurement result received by the measurement result reception unit 204 will be described with reference to FIG. 9. In the example of FIG. 9, the measurement result received by the measurement result reception unit 204 includes the identifier (Result ID (1)) of the measurement result, the identifier (Request ID (1)) of the corresponding measurement instruction, a time (Timestamp) when the prover device 100 calculates or transmits the measurement result, and a first hash value that is the measurement result. In the example of FIG. 9, the measurement results are three hash values of h1, h2, and h3. In addition, the measurement result may include a process identification (ID) (PID) of software being executed in the prover device 100.

The measurement unit 205 calculates a second hash value that is the hash value of the master software stored in the master storage unit 201. The hash value is calculated based on the nonce and the measurement region information included in the measurement instruction generated by the measurement instruction generation unit 202. The calculation method is the same as that in FIG. 4B.

The verification unit 206 verifies whether the first hash value, which is the measurement result received by the measurement result reception unit 204, matches the second hash value calculated by the measurement unit 205. When the values match, it can be confirmed that the software being executed by the prover device 100 has not been modified. When the values do not match, it can be confirmed that the software executed in the prover device 100 may have been modified. The verification unit 206 outputs the verification result to the evidence collection instruction generation unit 207.

The evidence collection instruction generation unit 207 generates an evidence request instruction for requesting necessary evidence data on the basis of the verification result based on the result of the measurement by the verification unit 206. Specifically, if the software is suspected of having been modified, the raw data of the software used to calculate the first hash value, which is the measurement result received by the measurement result reception unit 204, is requested as evidence data.

For example, if the first hash values h1, h2, h3, which are the measurement results, all differ from the second hash value, there is a possibility that a modification has been made at least in the data1 region, and thus a part of software corresponding to data1 is requested as evidence. If only h3 of the first hash values differs from the second hash value, it is understood that no tampering has been performed in the data1 and data3 regions, and thus a part of software corresponding to data2 is requested as evidence. In the former case, since there is a possibility that tampering is performed in the data3 and data2 regions, the data3 and data2 regions may also be requested as evidence, or all of the software may be requested as evidence.

A specific example of the evidence collection instruction generated by the evidence collection instruction generation unit 207 will be described with reference to FIG. 10. In the example of FIG. 10, the evidence collection instruction includes the identifier (Request ID (2)) of the evidence collection instruction, a time (Timestamp) when the evidence collection instruction generation unit 207 generates the evidence collection instruction or when the evidence collection instruction transmission unit 208 transmits the evidence collection instruction, the identifier (Result ID (1)) of the measurement result that has caused the evidence collection instruction to be generated, the name (Name) of the software that is the requested evidence data, the start position (Address) of the software in the memory, and the size (Size) of the software.

In FIG. 10, the evidence collection instruction (Request ID (2): 1) in the first row is an example of requesting only data1 since the start position and the size of data1 are designated. The evidence collection instruction (Request ID (2): 2) in the second row is an example of requesting data1, data3, and data2 since the start position of data1 and the total size of data1, data3, and data2 are designated. The evidence collection instruction (Request ID (2): 3) on the third line is an example of requesting the entire software since the start position of data1 and the size of the entire target software are designated.

The evidence collection instruction transmission unit 208 transmits, to the prover device 100, the evidence collection instruction generated by the evidence collection instruction generation unit 207.

The evidence data reception unit 209 receives evidence data from the prover device 100. The received evidence data is output to the difference extraction unit 211.

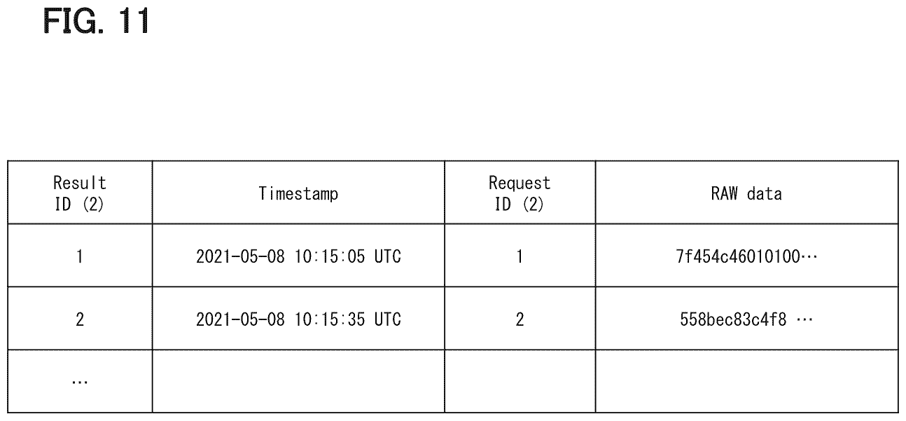

A specific example of the evidence data received by the evidence data reception unit 209 will be described with reference to FIG. 11. In the example of FIG. 11, the evidence data includes the identifier (Result ID (2)) of the evidence data, a time (Timestamp) when the evidence data reception unit 209 receives the evidence data, the identifier (Request ID (2)) of the corresponding evidence collection instruction, and the raw data (RAW data) of the software that is the evidence data.

The failure identification data reception unit 210 receives failure identification data from the prover device 100. The received failure identification data is output to the cause determination unit 213. When failure identification data is received together with a measurement result or evidence data, the measurement result reception unit 204 or the evidence data reception unit 209 may function as the failure identification data reception unit 210.

The difference extraction unit 211 compares the evidence data received by the evidence data reception unit 209 with the master software stored in the master storage unit 201, and extracts a difference therebetween. The difference between the evidence data and the master software refers to a part where a “modification” has been made to the software that is the evidence data compared to the master software.

The “modification” means that the software has content different from the master software and includes deletions, changes (including overwrites), or additions.

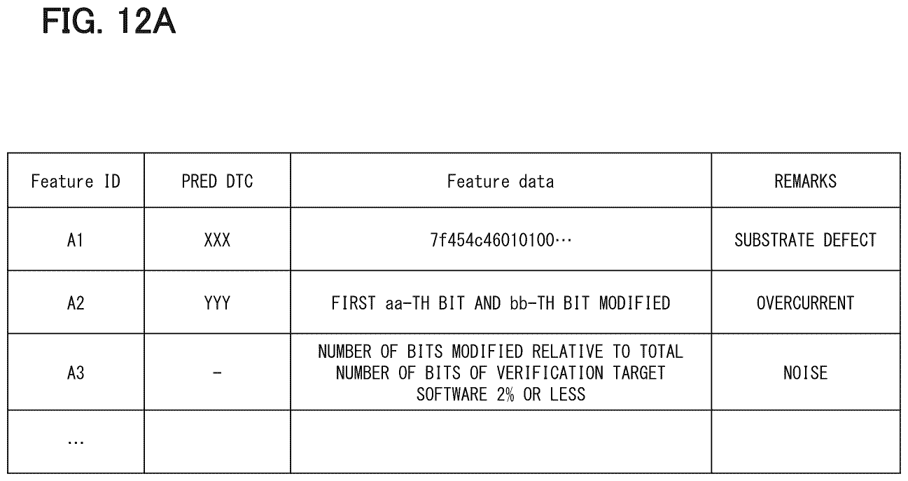

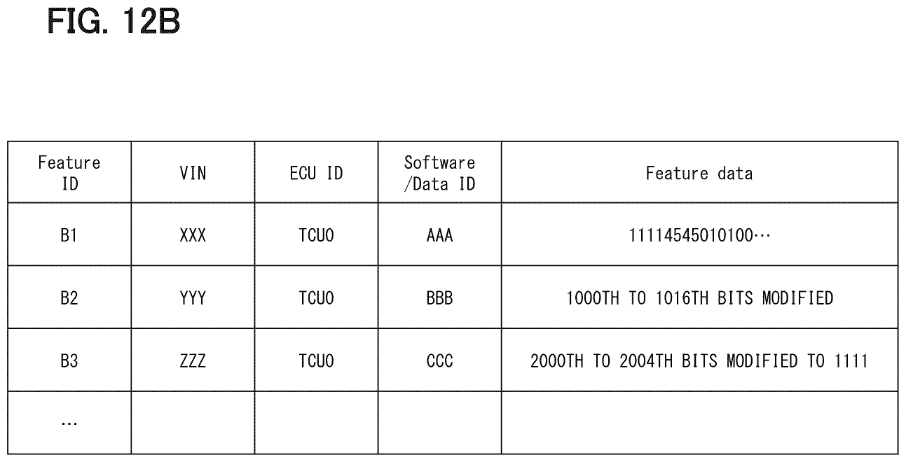

The feature data storage unit 212 stores feature management tables including failure-time modification feature data and attack-time modification feature data. Specific examples of the feature management tables will be described with reference to FIGS. 12A and 12B.

FIG. 12A is a diagram illustrating a failure-time feature management table. As illustrated in FIG. 12A, the failure-time feature management table associates and stores a feature identifier (feature ID) that identifies feature data, predicted failure identification data (PRED DTC) that is predicted to be generated by the prover device 100 when a “failure” occurs in the prover device 100, and failure-time modification feature data (feature data) indicating a feature of a software modification that is predicted to occur in the software placed in the memory 102 when a “failure” occurs in the prover device 100. Moreover, for illustrative purposes, FIG. 12A illustrates, as remarks, the content of the failure predicted to occur in the prover device 100. In addition, a vehicle identifier (VIN) that identifies a vehicle, an identifier (ECU ID) of an ECU in which software is installed, and an identifier (Software/Data ID) that identifies a program or data included in executed software may be included.

The “failure” refers to a situation where an originally assumed function or operation cannot be performed without the intention of another person and can, for example, be caused by a factor such as aging, load, noise, or poor quality.

For example, the first row in FIG. 12A is an example indicating that a DTC of XXX (PRED DTC: 1) is predicted to be generated by the prover device 100 in the event of a substrate defect failure in the prover device 100, and a specific portion of the software placed in the memory 102 is predicted to be modified to [7f454c46010100 . . . ] (Feature data: 1). The second row is an example indicating that a DTC of YYY (PRED DTC: 2) is predicted to be generated in the prover device 100 in the event of an overcurrent failure in the prover device 100, and the first aa-th bit and bb-th bit of the software placed in the memory 102 are predicted to be modified (Feature data: 2). In addition, the third row indicates that in the event of noise occurrence in the prover device 100, the number of bits modified relative to the total number of bits of the verification target software is predicted to be 2% or less (Feature data: 3). The predicted failure identification data is not associated with the failure-time modification feature data in the third row. This is because the noise generated in the prover device 100 is not detected by the self-diagnosis function, and a DTC is not generated. As illustrated in the third row of the feature management table in FIG. 12A, the failure-time modification feature data and the predicted failure identification data do not necessarily have to be associated with each other. In addition, the failure-time modification feature data may be represented by raw data after modification as illustrated in the first row, or may be represented by a portion to be modified, the number of bits to be modified, and the like as illustrated in the second and third rows.

FIG. 12B is a diagram illustrating an attack-time feature management table. As illustrated in FIG. 12B, the attack-time feature management table associates and stores a feature identifier (Feature ID) that identifies feature data, a vehicle identifier (VIN) that identifies a vehicle, an identifier (ECU ID) of an ECU in which software is installed, an identifier (Software/Data ID) that identifies a program or data included in executed software, and attack-time modification feature data that indicates a feature of a software modification predicted to occur in the software placed in the memory 102. The attack-time feature management table is generated, for example, by accumulating attack cases that occurred in the past.

For example, the first row in FIG. 12B is an example indicating that in the event of an attack on software where the vehicle identifier is XXX (VIN: 1), the ECU identifier is TCU0 (ECU ID: 1), and the identifier of the program included in the executed software is AAA (Software/Data ID: 1), a specific portion of the software placed in the memory 102 is predicted to be modified to [11114545010100 . . . ] (Feature data: 1). The second row is an example indicating that in an event of an attack on software where the vehicle identifier is YYY (VIN: 2), the identifier of the ECU is TCU0 (ECU ID: 2), and the identifier of the program included in the executed software is BBB (Software/Data ID: 2), the 1000th to 1016th bits (Feature data: 2) of the software placed in the memory 102 are predicted to be modified. In addition, the third row is an example indicating that in an event of an attack on software where the vehicle identifier is ZZZ (VIN: 3), the ECU identifier is TCU0 (ECU ID: 3), and the identifier of the program included in the executed software is CCC (Software/Data ID: 3), the 2000th to 2004th bits (Feature data: 3) of the software placed in the memory 102 are predicted to be modified to. The attack-time modification feature data may also be represented by a portion to be modified, the number of bits to be modified, or the like, similarly to the failure-time modification feature data.

The cause determination unit 213 determines the cause of the modification of the software placed in the memory 102 of the prover device 100 based on the difference extracted by the difference extraction unit 211. Specifically, the cause determination unit 213 determines the cause by using the failure-time modification feature data and the attack-time modification feature data stored in the feature data storage unit 212 and the difference extracted by the difference extraction unit 211. The cause of the modification of the software refers to an event that triggers the software modification.

For example, when the difference extracted by the difference extraction unit 211 “corresponds” to the failure-time modification feature data stored in the feature data storage unit 212, the cause determination unit 213 determines that the cause of the software modification is a failure.

The difference is considered to “correspond” to the modification feature data when the difference and the modification feature data can be evaluated as substantially matching, even if not perfectly identical.

In the present embodiment, the failure identification data reception unit 210 receives the failure identification data from the prover device 100. Therefore, the cause determination unit 213 may determine that the cause of the software modification is a failure when the difference extracted by the difference extraction unit 211 corresponds to the failure-time modification feature data and the failure identification data received by the failure identification data reception unit 210 “corresponds” to the predicted failure identification data.

Similarly, when the difference extracted by the difference extraction unit 211 “corresponds” to the attack-time modification feature data stored in the feature data storage unit 212, the cause determination unit 213 determines that the cause of the software modification is an attack. In the present embodiment, the attack-time modification feature data is associated with a vehicle identifier, an ECU identifier, and an identifier of a program or the like. Therefore, when the vehicle identifier of the vehicle in which the prover device 100 that has transmitted the evidence data is mounted, the identifier of the ECU in which the prover device 100 is provided, and the identifier of the program or the like to be measured all correspond to the vehicle identifier, the ECU identifier, and the identifier of the program or the like included in the feature management table, it may be determined that the cause of the software modification is an attack.

When the difference corresponds to neither the failure-time modification feature data nor the attack-time modification feature data, the cause determination unit 213 may determine that the cause of the software modification is unknown. When the difference corresponds to both the failure-time modification feature data and the attack-time modification feature data, the cause determination unit 213 may determine that the cause of the software modification is both a failure and an attack.

The cause determination unit 213 may further calculate the “probability” that the cause of the software modification is a failure or an attack based on the degree of coincidence between the difference and the failure-time modification feature data or the attack-time modification feature data. For example, when the failure-time modification feature data is represented by the raw data after modification, if the difference and the failure-time modification feature data all coincide with each other, the probability that the modification cause is a failure is calculated to be 100%. If the difference and the failure-time modification feature data coincide with each other by 90%, the probability that the modification cause is a failure is calculated to be 90%. Alternatively, as in the third row of FIG. 12B, when the attack-time modification feature data is represented by a portion to be modified and the raw data after modification, if the difference and the attack-time modification feature data all coincide with each other, the probability that the modification cause is an attack is calculated to be 100%. If only the difference and the modified portion of the attack-time modification feature data coincide with each other and the difference and the raw data after modification are different, the probability that the modification cause is an attack is calculated to be 90%. Even if the modified portion is the same, the raw data after modification may be different depending on the attacker. Therefore, as in this example, even if the difference and the attack-time modification feature data are partially different, it may be determined that the modification cause is an attack, and it may be determined that the probability is lower than 100% but relatively high. Although the configuration in which the numerical value is calculated as the probability has been described here, the probability does not necessarily have to be calculated as a numerical value. For example, the probability may be expressed as high, medium, or low.

The “probability” is an index indicating the likelihood of the determination result of the cause determination unit and includes not only a continuous numerical value but also a case where the probability is expressed by a discrete degree, a symbol, or the like.

In addition to the degree of coincidence between the difference and the modification feature data, the cause determination unit 213 may determine the probability that the modification cause is a failure or an attack based on the degree of coincidence between the identifier of the vehicle in which the software to be measured is mounted, the ECU identifier, and the identifier of the program or the like, and the vehicle identifier, the ECU identifier, and the identifier of the program or the like included in the feature management table.

In the present embodiment, the configuration in which the feature data storage unit 212 stores the failure-time modification feature data and the attack-time modification feature data has been described. However, the feature data storage unit 212 may store only one of the failure-time modification feature data or the attack-time modification feature data. In this case, for example, the cause determination unit 213 determines that the modification cause is an attack when the difference does not correspond to the failure-time modification feature data stored in the feature data storage unit 212, or determines that the modification cause is an attack when the difference does not correspond to the failure-time modification feature data stored in the feature data storage unit 212.

The cause information output unit 214 outputs cause information indicating the cause determined by the cause determination unit 213. When determining that the modification cause is a failure, the cause determination unit 213 outputs cause information indicating that the cause is a failure, and when determining that the modification cause is an attack, the cause determination unit outputs cause information indicating that the cause is an attack. When the cause determination unit 213 has calculated the probability of the determination result, the cause information output unit 214 may output the calculated probability together with the cause information.

The cause information output unit 214 outputs cause information to, for example, a treatment unit (not illustrated) that that handles software modifications. When the cause information indicates that the modification cause is an attack, the treatment unit takes provisional action (e.g., collecting additional evidence data, stopping the software, etc.) to address the attack. Alternatively, cause information or evidence data may be transmitted to the vehicle SOC or PSIRT to perform detailed analysis on the attack. In the present embodiment, by determining whether the cause of the software modification is an attack or a failure, it is possible to take action suitable for the modification cause.

### (3) Operation of Verifier Device 200

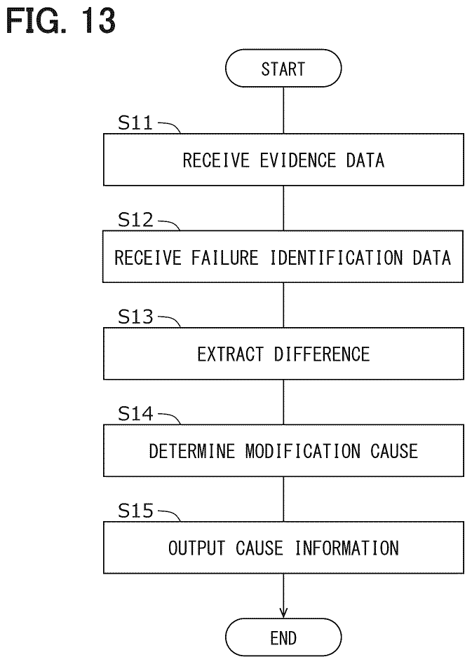

The operation of the verifier device 200 after remote attestation will be described with reference to FIG. 13. FIG. 13 illustrates not only a verification method executed by the verifier device 200 but also a processing procedure for a verification program executable by the verifier device 200. The processing to be described is not limited to the order indicated in FIG. 13. That is, the order may be interchanged unless there are restrictions, such as a relationship in which one step uses the result of its preceding step.

The evidence data reception unit 209 of the verifier device 200 receives evidence data from the prover device 100 (S11).

The failure identification data reception unit 210 receives failure identification data from the prover device 100 (S12).

The difference extraction unit 211 extracts a difference between software, which is the evidence data received in S11, and master software stored in the master storage unit 201 (S13).

The cause determination unit 213 determines the cause of the software modification based on the difference extracted in S13 (S14).

The cause information output unit 214 outputs cause information indicating the cause determined in S14 (S15).

### (4) Summary

As described above, according to the verifier device 200 of the present embodiment, the difference between the modified software and the master software can be extracted, and the cause of the software modification can be determined based on the extracted difference.

Moreover, according to the present embodiment, by determining the cause of the software modification, it is possible to take action corresponding to the cause of the modification.

Although the present first embodiment has been described on the premise of the remote attestation system 1, the first embodiment may be applied to a system other than the remote attestation system 1. That is, the present invention may be applied to a device that determines a cause of a software modification using a difference between modified software and master software without assuming remote attestation.

### 3. Second Embodiment

In the first embodiment, the configuration in which the cause of the software modification is determined using failure-time modification feature data or attack-time modification feature data has been described. In the present embodiment, a configuration in which the cause is determined based on the portion where the software modification has occurred will be described. The configurations and operations of the prover device 100 and the verifier device 200 are the same as those in the first embodiment, and thus, the description of the first embodiment will be referred to.

The cause determination unit 213 of the present embodiment determines the cause of the software modification based on the portion where the difference extracted by the difference extraction unit 211 has occurred and whether the difference is valid. That the difference is valid means that the modification in the software is a meaningful modification. Further, the fact that the difference is invalid means that the modification in the software is a meaningless modification.

For example, when the difference, extracted by the difference extraction unit 211, has occurred in the command part of the software, and evidence data received by the evidence data reception unit 209 is disassembled to obtain valid source code, the cause determination unit 213 determines that the cause of the software modification is an attack. The valid source code refers to meaningful source code, and the invalid source code is meaningless source code.

When the command part of the software is modified due to a failure, the modification is not intentionally performed, and thus the modified source code is often meaningless source code. In contrast, when the command part of the software is modified due to an attack, the command part is modified to a command part that affects the operation of the vehicle. That is, the source code intentionally modified by the attacker is usually meaningful source code. Therefore, when the difference has occurred in the command part of the software and evidence data that is modified software is disassembled to obtain valid source code, it is determined that the cause of the modification is an attack.

In another example, when the difference has occurred in a file path part and the file path part exists in other software, the cause determination unit 213 determines that the cause of the software modification is an attack.

When the file path part of the software is modified due to a failure, the modification is not intentionally performed, and thus, the modified file path part is usually a meaningless file path, that is, a non-existent file path in many cases. In contrast, when the file path part of the software is modified due to an attack, the software intentionally modified by the attacker usually refers to an inappropriate file or folder by designating an existing file path part. Therefore, when the difference has occurred in the file path part of the software and the modified file path part exists in the software, it is determined that the cause of the modification is an attack.

In still another example, when the difference has occurred in a domain part and the domain part can be resolved through name resolution, the cause determination unit 213 determines that the cause of the software modification is an attack.

When the domain part of the software is modified due to a failure, the modification is not intentionally performed, and thus the modified domain part is usually a domain part that cannot be converted into an appropriate IP address, that is, is not valid. In contrast, when the domain part of the software is modified due to an attack, the domain name part intentionally modified by the attacker is usually a domain name that can be converted into an existing IP address, that is, can be resolved through name resolution, thereby urging connection to an inappropriate IP address. Therefore, when the difference has occurred in the domain name part of the software and the modified domain name part can be resolved through name resolution, it is determined that the cause of the modification is an attack.

### 4. General Remarks

The features of the verifier device, the verification method, and the verification program in each embodiment of the present disclosure have been described above.

Since the terms used in each embodiment are examples, these may be replaced with terms that are synonymous or include synonymous functions.

The block diagram used for the description of each embodiment is obtained by classifying and arranging the configuration of the device by function. The block showing each function is implemented by any combination of hardware and software. In addition, since the functions are shown, the block diagram can be understood as a disclosure of a method and a disclosure of a program to implement the method.

The order of the functional blocks that can be understood as the processing, the flow, and the method described in each embodiment may be changed unless there are restrictions, such as a relationship in which one step uses the result of another step in the preceding step.

The terms first, second, or N (N is an integer) are used to distinguish between two or more configurations or methods of the same type and do not limit the order or superiority.

The following are examples of the forms of devices of the present disclosure.

Examples of the form of the component include a semiconductor element, an electronic circuit, a module, and a microcomputer.

Examples of the form of the semi-finished product include an electronic control device (electric control unit, ECU) and a system board.

Examples of the form of the finished product include a mobile phone, a smartphone, a tablet, a personal computer (PC), a workstation, and a server.

In addition, devices with communication functions, and the like are included, and examples thereof include a video camera, a still camera, and a car navigation system.

To each device, necessary functions such as an antenna and a communication interface may be added.

The verifier device of the present disclosure is assumed to be used for the purpose of providing various services, especially when used on the server side. With the provision of such services, the verifier device of the present disclosure will be used, the verification method of the present disclosure will be used, and/or the verification program of the present disclosure will be executed.

In addition, the present disclosure can be implemented not only with dedicated hardware configured and functioning as described in each embodiment, but also through a combination of a program, recorded in a recording medium such as memory or a hard disk, for realizing the present disclosure with general-purpose hardware, including a dedicated or general-purpose CPU, memory, and the like, capable of executing the program.

The program stored in a non-transitory tangible recording medium (e.g., an external storage device (hard disk, USB memory, CD/BD, etc.) or an internal storage device (RAM, ROM, etc.)) of dedicated or general-purpose hardware can also be provided to dedicated or general-purpose hardware via a recording medium, or from a server via a communication line without a recording medium. As a result, it is possible to always provide the latest functions through program upgrade.

The present disclosure has mainly described the case where an in-vehicle electronic control device mounted in an automobile is used as a prover device. However, the present disclosure can be applied to all moving objects such as motorcycles, ships, trains, and aircraft. The present disclosure is applicable not only to moving objects but also to all products including microcomputers.

### (Examples of the Technical Concepts Disclosed Herein)

### (Item 1)

A verifier device in a remote attestation system including a prover device and a verifier device, wherein the prover device transmits a measurement result in response to a measurement instruction from the verifier device, and the verifier device transmits an evidence collection instruction requesting evidence data in response to the measurement result from the prover device, and the prover device transmits the evidence data in response to the evidence collection instruction from the verifier device, the verifier device comprising:
an evidence data reception unit configured to receive the evidence data, which is software, from the prover device that places and executes the software in a memory;
a master storage unit configured to store master software, which is a copy of the software;
a difference extraction unit configured to extract a difference between the evidence data received and the master software;
a cause determination unit configured to determine a cause of modification of the software based on the difference; and
a cause information output unit configured to output cause information indicating the cause determined.

### (Item 2)

The verifier device according to item 1, further comprising:
a characteristic data storage unit configured to store fault modification characteristic data indicating characteristics of modification to the software that are expected to occur in the software placed in the memory when a fault occurs in the prover device,
wherein
the cause determination unit determines that the cause is a fault in the prover device when the difference corresponds to the fault modification characteristic data, and
the cause information output unit outputs the cause information indicating that the cause is the fault.

### (Item 3)

The verifier device according to item 2, wherein
the cause determination unit further calculates a degree of certainty that the cause is a fault in the prover device based on a degree of match between the difference and the fault modification characteristic data, and
the cause information output unit outputs the degree of certainty along with the cause information.

### (Item 4)

The verifier device according to item 2, further comprising:
a fault identification data reception unit configured to receive fault identification data from the prover device, the fault identification data identifying that a fault has occurred in the prover device,
wherein
the characteristic data storage unit stores predicted fault identification data expected to be generated in the prover device when a fault occurs, in association with the fault modification characteristic data, and
the cause determination unit determines that the cause is a fault in the prover device when the difference corresponds to the fault modification characteristic data and the fault identification data corresponds to the predicted fault identification data.

### (Item 5)

The verifier device according to item 1, further comprising:
a characteristic data storage unit configured to store attack modification characteristic data indicating characteristics of modification to the software that are expected to occur in the software placed in the memory when the prover device is attacked,
wherein
the cause determination unit determines that the cause is an attack on the prover device when the difference corresponds to the attack modification characteristic data, and
the cause information output unit outputs the cause information indicating that the cause is the attack.

### (Item 6)

The verifier device according to item 5, wherein
the cause determination unit further calculates a degree of certainty that the cause is a fault in the prover device based on a degree of match between the difference and the fault modification characteristic data, and
the cause information output unit outputs the degree of certainty along with the cause information.

### (Item 7)

The verifier device according to item 1, wherein
the cause determination unit determines the cause based on a location where the difference occurs.

### (Item 8)

The verifier device according to item 7, wherein
when the location is an instruction portion of the software and valid source code is obtained by disassembling the evidence data, the cause determination unit determines that the cause is an attack on the prover device.

### (Item 9)

The verifier device according to item 7, wherein
when the location is a file path portion of the software and the file path portion exists in another software, the cause determination unit determines that the cause is an attack on the prover device.

### (Item 10)

The verifier device according to item 7, wherein
when the location is a domain name portion of the software and the domain name portion can be resolved, the cause determination unit determines that the cause is an attack on the prover device.

### (Item 11)

The verifier device according to any one of item 1 to item 10, wherein
the verifier device is a server device installed outside a moving object.

### (Item 12)

The verifier device according to any one of item 1 to item 10, wherein
the verifier device is an electronic control device mounted in a moving object.

What is claimed is:

1. A verifier device in a remote attestation system including a prover device and a verifier device, wherein the prover device transmits a measurement result in response to a measurement instruction from the verifier device, and the verifier device transmits an evidence collection instruction requesting evidence data in response to the measurement result from the prover device, and the prover device transmits the evidence data in response to the evidence collection instruction from the verifier device, the verifier device comprising:
an evidence data reception unit configured to receive the evidence data, which is software, from the prover device that places and executes the software in a memory;
a master storage unit configured to store master software, which is a copy of the software;
a difference extraction unit configured to extract a difference between the evidence data received and the master software;
a cause determination unit configured to determine a cause of modification of the software based on the difference; and
a cause information output unit configured to output cause information indicating the cause determined.

2. The verifier device according to claim 1, further comprising:
a characteristic data storage unit configured to store fault modification characteristic data indicating characteristics of modification to the software that are expected to occur in the software placed in the memory when a fault occurs in the prover device,
wherein
the cause determination unit determines that the cause is a fault in the prover device when the difference corresponds to the fault modification characteristic data, and
the cause information output unit outputs the cause information indicating that the cause is the fault.

3. The verifier device according to claim 2, wherein
the cause determination unit further calculates a degree of certainty that the cause is a fault in the prover device based on a degree of match between the difference and the fault modification characteristic data, and
the cause information output unit outputs the degree of certainty along with the cause information.

4. The verifier device according to claim 2, further comprising:
a fault identification data reception unit configured to receive fault identification data from the prover device, the fault identification data identifying that a fault has occurred in the prover device,
wherein
the characteristic data storage unit stores predicted fault identification data expected to be generated in the prover device when a fault occurs, in association with the fault modification characteristic data, and
the cause determination unit determines that the cause is a fault in the prover device when the difference corresponds to the fault modification characteristic data and the fault identification data corresponds to the predicted fault identification data.

5. The verifier device according to claim 1, further comprising:
a characteristic data storage unit configured to store attack modification characteristic data indicating characteristics of modification to the software that are expected to occur in the software placed in the memory when the prover device is attacked,
wherein
the cause determination unit determines that the cause is an attack on the prover device when the difference corresponds to the attack modification characteristic data, and
the cause information output unit outputs the cause information indicating that the cause is the attack.

6. The verifier device according to claim 5, wherein
the cause determination unit further calculates a degree of certainty that the cause is a fault in the prover device based on a degree of match between the difference and fault modification characteristic data, and
the cause information output unit outputs the degree of certainty along with the cause information.

7. The verifier device according to claim 1, wherein
the cause determination unit determines the cause based on a location where the difference occurs.

8. The verifier device according to claim 7, wherein
when the location is an instruction portion of the software and valid source code is obtained by disassembling the evidence data, the cause determination unit determines that the cause is an attack on the prover device.

9. The verifier device according to claim 7, wherein
when the location is a file path portion of the software and the file path portion exists in another software, the cause determination unit determines that the cause is an attack on the prover device.

10. The verifier device according to claim 7, wherein
when the location is a domain name portion of the software and the domain name portion can be resolved, the cause determination unit determines that the cause is an attack on the prover device.

11. The verifier device according to claim 1, wherein
the verifier device is a server device installed outside a moving object.

12. The verifier device according to claim 1, wherein
the verifier device is an electronic control device mounted in a moving object.

13. A verification method executed by a verifier device in a remote attestation system including a prover device and a verifier device, wherein the prover device transmits a measurement result in response to a measurement instruction from the verifier device, and the verifier device transmits an evidence collection instruction requesting evidence data in response to the measurement result from the prover device, and the prover device transmits the evidence data in response to the evidence collection instruction from the verifier device, the verification method comprising:
receiving, from the prover device that places and executes software in a memory, the evidence data, which is the software;
extracting a difference between the evidence data received and master software, which is a copy of the software;
determining a cause of modification of the software based on the difference; and
outputting cause information indicating the cause determined.

14. A non-transitory computer-readable storage medium storing a verification program executable by a verifier device in a remote attestation system including a prover device and a verifier device, wherein the prover device transmits a measurement result in response to a measurement instruction from the verifier device, and the verifier device transmits an evidence collection instruction requesting evidence data in response to the measurement result from the prover device, and the prover device transmits the evidence data in response to the evidence collection instruction from the verifier device, the verification program causing the verifier device to execute:
receiving, from the prover device that places and executes software in a memory, the evidence data, which is the software;
extracting a difference between the evidence data received and master software, which is a copy of the software;
determining a cause of modification of the software based on the difference; and
outputting cause information indicating the cause determined.

15. A remote attestation system comprising
a prover device, and
a verifier device,
wherein
the prover device which is a device that places and executes software in a memory, the prover device including:
a measurement instruction reception unit that receives a measurement instruction from the verifier device,
a measurement unit that reads the software placed in the memory and calculates a measurement value based on the measurement instruction,
a measurement result transmission unit that transmits the measurement value as a measurement result to the verifier device,
an evidence collection instruction reception unit that receives an evidence collection instruction generated by the verifier device based on the measurement result,
an evidence data collection unit that collects the software used for calculating the measurement value as evidence data based on the evidence collection instruction, and
an evidence data transmission unit that transmits the evidence data to the verifier device, and
the verifier device is a device that verifies integrity of the software executed by the prover device, the verifier device including:
a measurement instruction generation unit that generates the measurement instruction,
a measurement instruction transmission unit that transmits the measurement instruction to the prover device,
a measurement result reception unit that receives the measurement result from the prover device,
an evidence collection instruction generation unit that generates the evidence collection instruction requesting the software used for calculating the measurement value as evidence data when the software is modified based on verification of the measurement result,
an evidence collection instruction transmission unit that transmits the evidence collection instruction to the prover device,
an evidence data reception unit that receives the evidence data from the prover device,
a master storage unit that stores master software, which is a copy of the software,
a difference extraction unit that extracts a difference between the received evidence data and the master software,
a cause determination unit that determines a cause of modification of the software in the prover device based on the difference, and
a cause information output unit that outputs cause information indicating the determined cause.

16. The remote attestation system according to claim 15, wherein the measurement value is a hash value.
